(19) United States
(12) Patent Application Publication
(10) Pub. No.: US 2016/0274292 A1
(43) Pub. Date: Sep. 22, 2016

(54) LIGHTING DEVICE, DISPLAY DEVICE AND TELEVISION RECEIVING DEVICE

(71) Applicant: Sharp Kabushiki Kaisha, Osaka (JP)

(72) Inventor: Takaharu SHIMIZU, Osaka (JP)

(73) Assignee: Sharp Kabushiki Kaisha, Osaka (JP)

(21) Appl. No.: 14/901,951

(22) PCT Filed: Jun. 27, 2014
(86) PCT No.: PCT/JP2014/067133

§ 371 Date: Dec. 29, 2015

(30) Foreign Application Priority Data
Jul. 4, 2013 (JP) 2013-140623

(51) Int. Cl. F21V 8/00

(52) U.S. Cl. CPC G02B 6/0068

(57) ABSTRACT

A backlight device 24 includes: a light-guide plate 20 that has a rectangular plate-like shape, of which one long-side end face is a main light-entering face 20A and both short-side end faces are auxiliary light-entering faces 20B; a plurality of main LEDs 28A that are disposed in a line along the main light-entering face 20A, and that emit light that is subsequently received by the main light-entering face 20A; and a plurality of auxiliary LEDs 28B that are disposed in a line along each auxiliary light-entering face 20B, and that emit light that is subsequently received by the auxiliary light-entering faces 20B. The auxiliary LEDs 28B are configured such that a ratio of an area of light-emitting surfaces of the auxiliary LEDs 28B to an area of the auxiliary light-entering faces 20B is less than a ratio of an area of light-emitting surfaces of the main LEDs 28A to an area of the main light-entering face 20A.

### TECHNICAL FIELD

The present invention relates to an illumination device, a display device, and a TV receiver.

### BACKGROUND ART

A liquid crystal display device such as a liquid crystal television requires a separate backlight device as an illumination device since the liquid crystal panel, which is a display panel, does not emit light on its own, for example. Backlight devices are generally categorized into a direct-lit type and an edge-lit type based on the configuration. To achieve further thickness reduction of the liquid crystal display device, it is preferable to use an edge-lit backlight device.

In an edge-lit backlight device, a case houses a light guide plate that guides light emitted from light sources such as LEDs (light emitting diodes) toward a light-exiting surface that is provided on one surface of the light guide plate. A light-entering face is provided on at least one end face of the light guide plate. A plurality of light sources, such as LEDs, are arranged in a row facing the light-entering face.

However, in an edge-lit backlight device like that mentioned above, there may be instances where the amount of light at the edges of the light-entering face is lower compared to the center thereof as a result of the light emitted from the respective LEDs becoming focused toward the center rather than the edges of the light-entering face, depending on the number of LEDs in the plurality of LEDs that form a line and the arrangement gaps of the LEDs. This makes the edges of the display surface in the backlight device become relatively dark compared to the center of the display surface, which can make the brightness distribution on the display surface uneven. Patent Document 1, for example, discloses a backlight unit that aims to eliminate unevenness in the brightness distribution of such a display surface.

### RELATED ART DOCUMENT

### Patent Document

Patent Document 1: Japanese Patent Application Laid-Open Publication No. 2012-242649

### Problems to be Solved by the Invention

The backlight unit disclosed in Patent Document 1 above, however, eliminates unevenness in the brightness distribution of the display surface by providing between the light guide plate and the display surface an optical sheet capable of regulating brightness distribution so as to be even throughout the entire display surface. The optical sheet has a configuration that combines a plurality of substantially semispherical lenses and a plurality of geometric structures arranged in series. This configuration, however, makes the path the light travels in the optical sheet long, thereby lowering the usage efficiency of light.

### SUMMARY OF THE INVENTION

The technology disclosed in the present specification was made in view of the above-mentioned problems. The technology disclosed in the present specification aims to improve uniformity in the brightness distribution on the display surface without lowering the usage efficiency of light.

### Means for Solving the Problems

The technology disclosed in the present specification relates to an illumination device that includes: a light guide plate that has a rectangular plate-like shape, at least one long-side end face thereof being a main light-entering face and at least one short-side end face thereof being an auxiliary light-entering face; a plurality of main light sources disposed in a line along the main light-entering face, such that light emitted by the main light sources enters the main light-entering face; and a plurality of auxiliary light sources disposed in a line along the auxiliary light-entering face, such that light emitted by the auxiliary light sources enters the auxiliary light-entering face, wherein a ratio of an area of light-emitting surfaces of the auxiliary light sources to an area of the auxiliary light-entering face is less than a ratio of an area of light-emitting surfaces of the main light sources to an area of the main light-entering face.

In such an illumination device, the auxiliary light-entering face is provided on an end face of the light guide plate so as to be adjacent to the main light-entering face thereof. Since light is not just emitted from the main light sources toward the main light-entering face, but also emitted from the auxiliary light sources toward the auxiliary light-entering face, which is adjacent to the main light-entering face, insufficient brightness at the edges of the main light-entering face can be prevented or suppressed even in instances in which more light is focused at the center of the main light-entering face than the edges of the main light-entering face. Since the light guide plate has a rectangular shape, when thermal expansion occurs, the light guide plate expands further outward in the short-side direction than in the long-side direction. Therefore, when the light guide plate thermally expands, the distance in which the auxiliary light-entering face expands toward the auxiliary light sources is greater than the distance in which the main light-entering face expands toward the main light sources. Thus, in order for the auxiliary light sources to not impact and damage the auxiliary light-entering face during the thermal expansion of the light guide plate, the auxiliary light sources are disposed such that the distance between the auxiliary light sources and the auxiliary light-entering face is greater than the distance between the main light sources and the main light-entering face. As a result, the amount of light that reaches the auxiliary light-entering face is less than the amount of light that reaches the main light-entering face; thus, in the above-mentioned illumination device, the auxiliary light sources function as supplementary light sources.

However, in instances in which the number of auxiliary light sources is increased too much or the like, depending on the arrangement of the main light sources, the amount of light that the auxiliary light-entering face receives may be greater than the amount of light that the main light-entering face receives, which means that the auxiliary light sources no longer function as supplementary light sources, and that the brightness at the main light-entering face side of the display surface may decrease relative to the auxiliary light-entering face side. As a countermeasure, the main light sources and the auxiliary light sources are respectively disposed in the above-mentioned illumination device such that the ratio of the light-emitting surfaces of the auxiliary light sources to the auxiliary light-entering face, which is provided on a short-side end face of the light guide plate, is smaller than the ratio of the light-emitting surfaces of the main light sources to the main light-entering face, which is provided on a long-side end face of the light guide plate. As a result, the respective main light sources and auxiliary light sources are efficiently arranged, and it is possible to efficiently cause light to enter the main light-entering face and the auxiliary light-entering face without negatively impacting the ability of the auxiliary light sources to function as supplementary light sources. Thus, it is possible to prevent or suppress a condition in which the edges of the light-entering face are brighter than the center thereof, as well as prevent or suppress unevenness in brightness between the center and the edges of the display surface. It is also possible to prevent a decrease in the usage efficiency of light because the backlight device does not include a lens member or the like in the middle of the path of the light as in conventional technology. In the above-described illumination device, it is possible to improve uniformity in the brightness distribution on the display surface without lowering the usage efficiency of light.

The main light sources may be disposed such that the light-emitting surfaces thereof face the main light-entering face, the auxiliary light sources may be disposed such that the light-emitting surfaces thereof face the auxiliary light-entering face, and the ratio of the area of the light-emitting surfaces of the main light sources to the area of the main light-entering face may be represented by the formula B1×N1÷A1, and the ratio of the area of the light-emitting surfaces of the auxiliary light sources to the area of the auxiliary light-entering face may be represented by the formula B2×N2÷A2, where A1 and A2 represent the area of the main light-entering face and the area of the auxiliary light-entering face, respectively, B1 and B2 represent an area of the light-emitting surface of each of the main light sources and an area of the light-emitting surface of each of the auxiliary light sources, respectively, and N1 and N2 represent a number of the main light sources and a number of the auxiliary light sources, respectively.

In such a configuration, it is possible to provide a specific method for calculating the ratio of the area of the light-emitting surfaces of the main light sources to the area of the main light-entering face, and the ratio of the area of the light-emitting surfaces of the auxiliary light sources to the area of the auxiliary light-entering face.

The main light sources that are disposed adjacent to each other may have a substantially equal gap therebetween, the auxiliary light sources that are disposed adjacent to each other may have a substantially equal gap therebetween, and the main light sources may be disposed with a narrower gap therebetween than the auxiliary light sources.

In such a configuration, it is possible to provide a specific arrangement of the main light sources and the auxiliary light sources such that the ratio of the light-emitting surfaces of the auxiliary light sources to the auxiliary light-entering face is smaller than the ratio of the light-emitting surfaces of the main light sources to the main light-entering face.

Both short-side end faces of the light guide plate may respectively be the auxiliary light-entering face.

In such a configuration, light enters from both end faces adjacent to the main light-entering face of the light guide plate; thus, it is possible prevent or suppress a condition in which there is insufficient brightness at the edges of the main light-entering face compared to instances in which light enters from just one end face adjacent to the main light-entering face. As a result, it is possible to prevent or suppress unevenness in brightness between the center and the edges of the display surface.

One of the long-side end faces of the light guide plate may be the main light-entering face, and the auxiliary light sources may be disposed closer to another of the long-side end faces of the light guide plate.

When the one long-side end face of the light guide plate is the main light-entering face, it is difficult for light from the main light sources to reach the end face opposite to the main light-entering face, or in other words, the other long-side end face of the light guide plate. In the configuration mentioned above, light from the auxiliary light sources is received closer to the end face opposite to the main light-entering face; thus, it is possible on the display surface to prevent or suppress insufficient brightness at the end face opposite to the main light-entering face. As a result, it is possible to increase brightness uniformity on the display surface.

Both long-side end faces of the light guide plate may respectively be the main light-entering face.

In such a configuration, a large portion of the light from the main light sources and the auxiliary light sources is received by both respective long-side end faces of the light guide plate; thus, it is possible to increase brightness throughout the display surface compared to instances in which one long-side end face of the light guide plate is the main light-entering face.

The main light sources may be disposed so as to face almost the entire main light-entering face.

In such a configuration, it is easier for light to enter both ends of the main light-entering face; thus, it is possible to prevent or suppress insufficient brightness on the display surface in the corners located at both ends of the main light-entering face. As a result, it is possible to increase brightness uniformity on the display surface.

The technology disclosed in the present specification can be expressed as a display device that includes: the illumination device; and a display panel that utilizes light from the illumination device to perform display. A display device in which the display panel is a liquid crystal panel that utilizes liquid crystal is also novel and useful. A television receiver that includes the above-mentioned display device is also novel and useful.

### Effects of the Invention

The technology disclosed in the present specification can improve uniformity in the brightness distribution on the display surface without lowering the usage efficiency of light.

### BRIEF DESCRIPTION OF THE DRAWINGS

FIG. 1 is an exploded perspective view of a television receiver according to Embodiment 1.

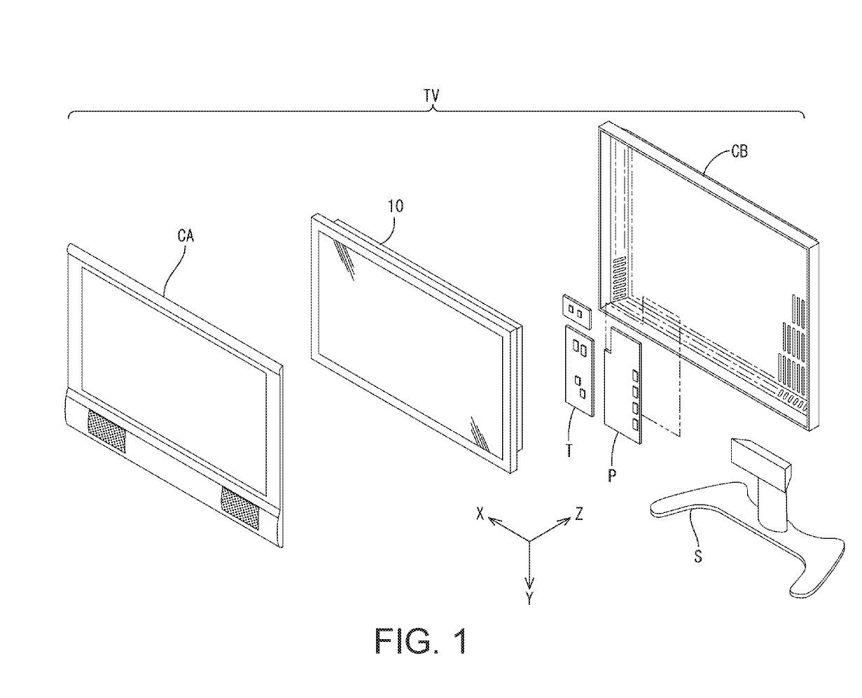

FIG. 2 is an exploded perspective view of a liquid crystal display device.

FIG. 3 is an enlarged cross-sectional view that enlarges the part of the liquid crystal display device near an LED in a cross-sectional view along the short side direction of a chassis.

FIG. 4 is a plan view from the front side of a backlight device.

FIG. 5 is an enlarged plan view in which the area near the LEDs in FIG. 4 has been enlarged.

FIG. 6 is a plan view from the front of a backlight device according to a modification example of Embodiment 1.

FIG. 7 is a plan view from the front side of a backlight device according to Embodiment 2.

FIG. 8 is a plan view from the front side of a backlight device according to a modification example of Embodiment 2.

FIG. 9 is an exploded perspective view of a liquid crystal display device according to Embodiment 3.

### DETAILED DESCRIPTION OF EMBODIMENTS

### Embodiment 1

Embodiment 1 will be described with reference to the drawings. In the present embodiment, a television receiver TV will be described as an example. Each of the drawings indicates an X axis, a Y axis, and a Z axis in a portion of the drawings, and each of the axes indicates the same direction for the respective drawings. The Y axis direction corresponds to the vertical direction, and the X axis direction corresponds to the horizontal direction. Unless otherwise noted, “up” and “down” in the description is based on the vertical direction.

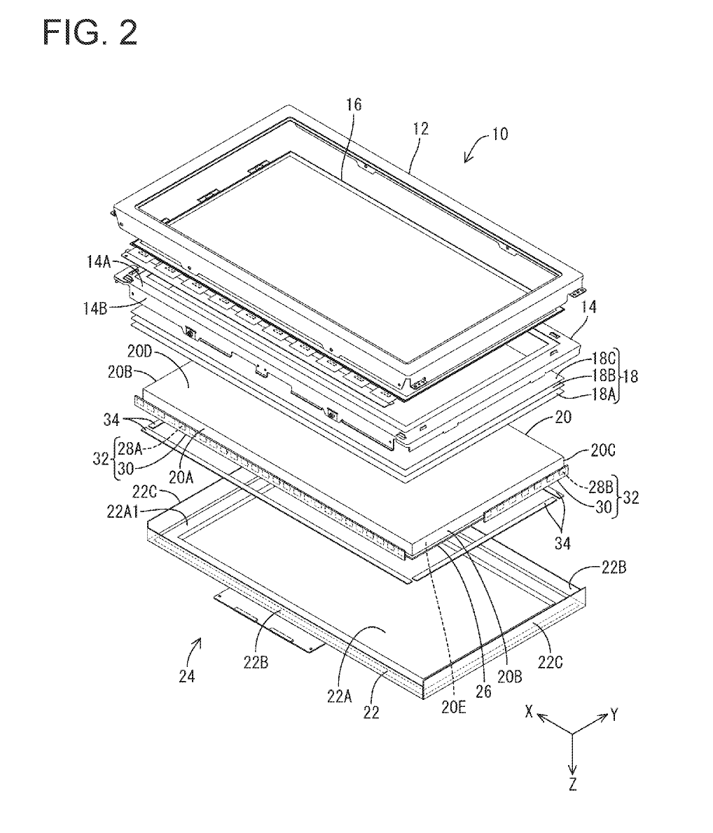

The television receiver TV includes: a liquid crystal display device 10 (one example of a display device); front and rear cabinets CA, CB that house the liquid crystal display device 10 therebetween, a power source P; a tuner T; and a stand S. The liquid crystal display device 10 has a horizontally-long quadrilateral shape as a whole, and, as shown in FIG. 2, includes: a liquid crystal panel 16 that is a display panel; and a backlight device 24 (one example of an illumination device) that is an external light source. These components are formed so as to be integrally held together by a bezel 12 or the like that has a frame-like shape. In the liquid crystal display device 10, the liquid crystal panel 16 is assembled with the display surface, which is capable of displaying images, facing toward the front.

Next, the liquid crystal panel 16 will be described. The liquid crystal panel 16 is configured such that a pair of transparent (having a high degree of light transmissivity) glass substrates are bonded together with a prescribed gap therebetween, and a liquid crystal layer (not shown) is sealed between the pair of glass substrates. One of the glass substrates is provided with: switching elements (TFTs, for example) that are connected to source wiring lines and gate wiring lines that intersect each other; pixel electrodes connected to the switching elements; an alignment film; and the like. The other glass substrate is provided with: color filters having respective colored portions such as R (red), G (green), and B (blue) arranged in a prescribed pattern; an opposite electrode; an alignment film; and the like. Of these, the source wiring lines, the gate wiring lines, the opposite electrode, and the like are provided with image data and various control signals necessary to display images from a driver circuit substrate (not shown). Polarizing plates (not shown) are disposed on respective outer sides of both glass substrates.

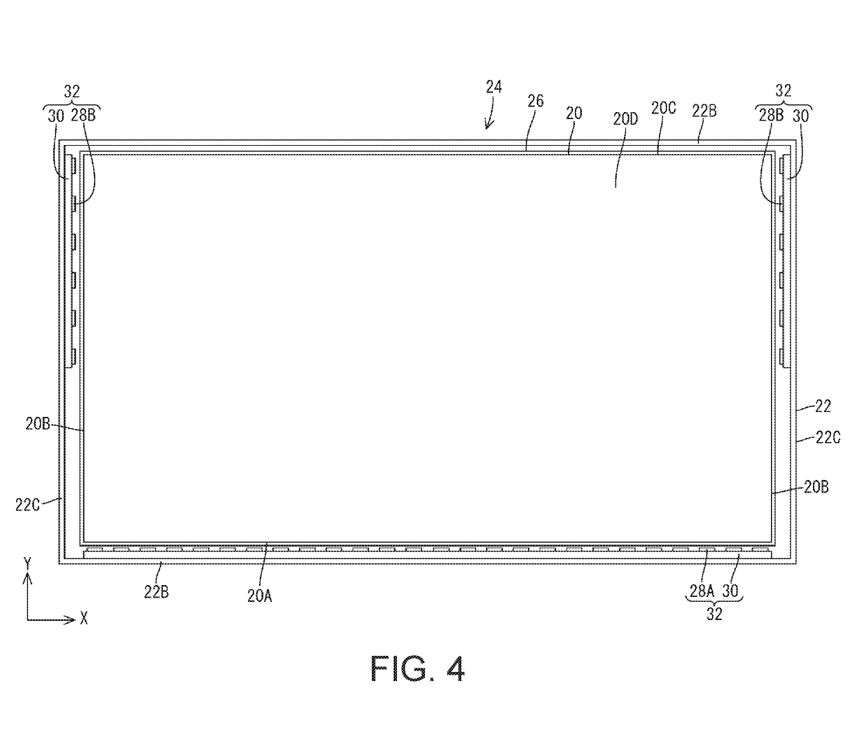

Next, the backlight device 24 will be described. As shown in FIG. 2, the backlight device 24 includes: a substantially box-shaped chassis 22 that opens toward the front (the light-exiting side, toward the liquid crystal panel 16); a frame 14 disposed to the front of the chassis 22; and an optical member 18 disposed so as to cover an opening of the frame 14. Furthermore, three LED (light-emitting diode) units 32 (see FIG. 4), four spacers 34, a reflective sheet 26, and a light guide plate 20 are housed inside the chassis 22. Respective end faces, except for one long-side end face 20C, of the light guide plate 20 are disposed so as to face the respective LED units 32, and guide light emitted from the LED units 32 toward the liquid crystal panel 16. The optical member 18 is placed on the front side of the light guide plate 20. The backlight device 24 of the present embodiment uses the so-called edge-lit method (side-lit method) in which the light guide plate 20 and the optical member 18 are disposed directly below the liquid crystal panel 16, and the LED units 32, which are light sources, are disposed on the side edges of the light guide plate 20. Each component of the backlight device 24 will be described in detail below.

The chassis 22 is made of a metal plate such as an aluminum plate or an electro-galvanized cold-rolled steel (SECC) plate, for example. As shown in FIG. 2, the chassis 22 is constituted of: a bottom plate 22A having a horizontally-long quadrangular shape similar to the liquid crystal panel 16; side walls 22B that rise from respective outer edges of both of the long sides of the bottom plate 22A; and side walls 22C that rise from respective outer edges of both of the short sides of the bottom plate 22A. The long side direction of the chassis 22 (the bottom plate 22A) corresponds to the X axis direction (horizontal direction), and the short side direction thereof corresponds to the Y axis direction (vertical direction). A frame-shaped (when seen in a plan view) protruding section 22A1 that protrudes towards the light guide plate 20 is provided on the edges of the surface of the bottom plate 22A. The top of the protruding section 22A1 is flat, and it is possible for the light guide plate 20 to be placed along the edges thereof via the above-mentioned respective spacers 34. The protruding section 22A1 supports the light guide plate 20 and the reflective sheet 26, which are housed inside the chassis 22, from the rear. A control substrate (not shown) for providing signals for driving the liquid crystal panel 16 is attached to the outside of the rear of the bottom plate 22A. In a manner similar to the control substrate described above, other substrates such as an LED driver circuit substrate (not shown) that provides driving power to the various LED units 32 are attached to the bottom plate 22A.

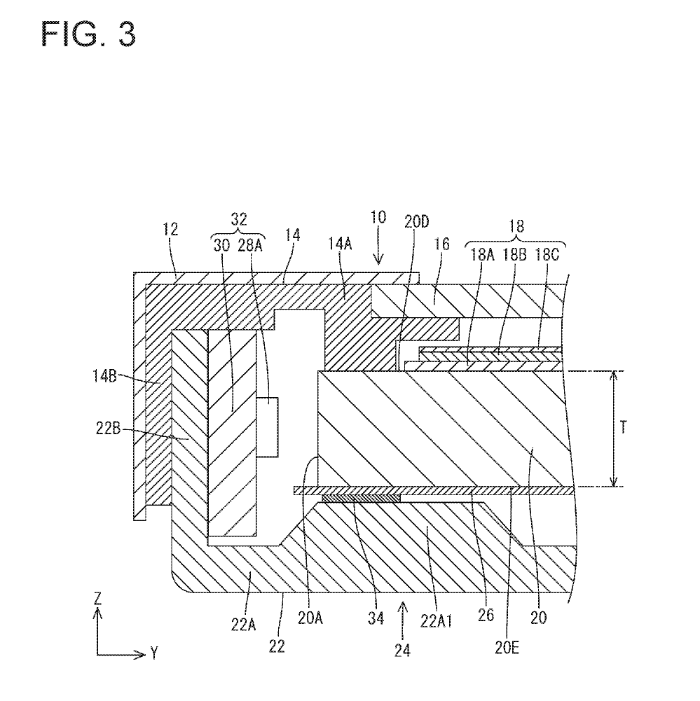

The frame 14 is made of a synthetic resin such as plastic or the like, and, as shown in FIGS. 2 and 3, is constituted of: a frame section 14A that has a substantially frame-like shape when seen in a plan view and that is parallel to the optical member 18 and the light guide plate 20 (the liquid crystal panel 16); and a cylindrical section 14B that has a substantially short tube-like shape and that protrudes from the peripheral edges of the frame section 14A toward the rear. The frame section 14A of the frame 14 extends along the peripheral edges of the light guide plate 20, and has the ability to cover nearly the entire peripheral edges of the optical member 18 and the light guide plate 20, which are disposed to the rear, from the front. Meanwhile, the inner edges of the frame section 14A are able to receive (support) nearly the entire peripheral edges of the liquid crystal panel 16, which is disposed to the front, from the rear. In other words, the frame section 14A is disposed so as to be interposed between the optical member 18 and the liquid crystal panel 16. In addition, both short side portions and one long side portion of the frame section 14A collectively cover from the front the respective end faces of the overlapping light guide plate 20 and the various LED units 32. The cylindrical section 14B of the frame 14 is attached to the outer surfaces of the side walls 22B, 22C of the chassis 22. The outer surface of the cylindrical section 14B is disposed so as to abut the inner surface of the cylindrically-shaped surface of the bezel 12 described above.

The optical member 18 is formed by stacking a diffusion sheet 18A, a lens sheet 18B, and a reflective polarizing sheet 18C in this order from the light guide plate 20 side. The diffusion sheet 18A, the lens sheet 18B, and the reflective polarizing sheet 18C change the light emitted from the LED units 32 and transmitted through the light guide plate 20 into planar light. The optical member 18 is placed on the front surface (light-exiting surface) of the light guide plate 20. As shown in FIG. 3, the optical member 18 and the liquid crystal panel 16 are separated by the frame section 14A of the frame 14. In this way, a prescribed space is formed between the optical member 18 and the liquid crystal panel 16.

The light guide plate 20 is made of a synthetic resin (an acrylic resin such as PMMA, a polycarbonate, or the like, for example) that has a refractive index sufficiently higher than that of air and that is almost completely transparent (has excellent light transmissivity). As shown in FIG. 2, the light guide plate 20 has, similar to the liquid crystal panel 16 and the chassis 22, a horizontally long quadrangular shape when seen in a plan view, and has a large plate-like shape that is thicker than the optical sheet 18. The light guide plate 20 is disposed such that the long side direction of the surface thereof corresponds to the X axis direction, the short side direction corresponds to the Y axis direction, and the thickness direction orthogonal to the plate surface thereof corresponds to the Z axis direction. One long-side end face of the light guide plate 20 is a main light-entering face 20A that receives light emitted from the main LEDs 28A, which will be explained later. Furthermore, both short-side end faces of the light guide plate 20 are auxiliary light-entering faces 20B that receive light emitted from the auxiliary LEDs 28B, which will be explained later. Therefore, the respective auxiliary light-entering faces 20B on the end faces of the light guide plate 20 are adjacent to the main light-entering face 20A. The other long-side end face of the light guide plate 20 is a non-light-entering face 20C that does not receive light.

As shown in FIGS. 2 and 4, the main light-entering face 20A and the auxiliary light-entering faces B of the light guide plate 20 face the respective LED units 32, and the light-exiting surface 20D, which is a main surface (the front surface), faces toward the optical sheet 18. The light guide plate 20 is disposed such that an opposite surface 20E, which is the surface (rear surface) opposite to the light-exiting surface 20D, is disposed so as to face toward the reflective sheet 26. The light guide plate 20 is supported by the protruding section 22A1, which will be explained later, of the chassis 22 with the reflective sheet 26 interposed therebetween. The light guide plate 20 is disposed such that the arrangement direction of the main LEDs 28A corresponds to the Y axis direction, the arrangement direction of the auxiliary LEDs 28B corresponds to the X axis direction, and the arrangement direction of the optical sheet 18 and the reflective sheet 26 corresponds to the Z axis direction. The light guide plate 20 receives light emitted from the respective LED units 32 at the main light-entering face 20A and the auxiliary light-entering faces 20B, propagates the light therein, orients the light upward toward the optical sheet 18, and then emits the light from the light-exiting surface 20D.

The reflective sheet 26 has a rectangular sheet-like shape, is made of a synthetic resin, and the surface thereof is white with excellent light-reflecting characteristics. The long side direction of the reflective sheet 26 corresponds to the X axis direction, the short side direction thereof corresponds to the Y axis direction, and the reflective sheet 26 is disposed so as to be sandwiched between the opposite surface 20E of the light guide plate 20 and the spacers 34 (see FIG. 3), which will be described later. The reflective sheet 26 has a reflective surface on the front side, and this reflective surface abuts the opposite surface 20E of the light guide plate 20. The reflective sheet 26 can reflect light that has leaked from the respective LED units 32 or the light guide plate 20 toward the reflective surface of the reflective sheet 26. In addition, the reflective sheet 26 is slightly larger than the opposite surface 20E of the light guide plate 20. As shown in FIGS. 2 and 3, the edges of the reflective sheet 26 stick out slightly beyond the edges of the light guide plate 20.

The four spacers 34 are respectively arranged so as to be along both long side directions and both short side directions of the chassis 22. Each of the spacers 34 has a flat plate-like shape. Each of the spacers 34 is placed on top of the protruding section 22A1 of the chassis 22. As described above, the edges of the reflective sheet 26 are sandwiched between the spacers 34 and the light guide plate 20. In this way, the reflective sheet 26 is fixed by being sandwiched between the spacers 34 and the light guide plate 20, and movement of the reflective sheet 26 in the plate surface direction of the light guide plate 20 (the plate surface direction of the bottom plate 22A of the chassis 22, the X-Y plane direction) is restricted. The reflective sheet 26 may be configured such that a portion of the outer edges thereof is not sandwiched between the spacers 34 and the light guide plate 20, thereby allowing the portion of the outer edges to move in the plate surface direction of the light guide plate 20. As a result, this portion of the outer edges may be used to help eliminate wrinkles in the reflective sheet 26 caused by thermal expansion or the like.

As shown in FIG. 4, there are three LED units 32, with one LED unit 32 being disposed along one long side of the chassis 22 and the two other LED units 32 being respectively disposed along the two respective short sides of the chassis 22. Each of the LED units 32 is formed of an LED substrate 30 and LEDs 28. The LED substrate (hereafter referred to as a long side LED substrate) 30 that forms a part of the LED unit 32 disposed on the one long side of the chassis 22 has an elongated plate-like shape extending along the long side direction of the light guide plate 20, the surface thereof being parallel to the X axis direction and the Z axis direction. In other words, the long side LED substrate 30 is housed inside the chassis 22 so as to be parallel to the main light-entering face 20A of the light guide plate 20. Meanwhile, LED substrates (hereafter referred to as short side LED substrates) 30 that form a part of the LED units 32 respectively disposed along the respective short sides of the chassis 22 have an elongated plate-like shape extending along the short side direction of the light guide plate 20, the surface thereof being parallel to the Y axis direction and the Z axis direction. In other words, the short side substrates 30 are housed inside the chassis 22 so as to be parallel to the auxiliary light-entering faces 20B of the light guide plate 20.

The length of the long side LED substrate 30 in the long side direction (the X axis direction) thereof is approximately the same as the length of the light guide plate 20 in the long side direction thereof. Meanwhile, the length of the short side LED substrates 30 in the long side direction (the Y axis direction) thereof is approximately half the length of the light guide plate 20 in the short side direction thereof. The long side LED substrate 30 extends so as to oppose nearly the entire main light-entering face 20A of the light guide plate 20, while the respective short side LED substrates 30 are respectively disposed closer to the non-light-entering face 20C of the light guide plate 20. Specifically, the respective short side LED substrates 30 extend so as to oppose approximately the half of the respective auxiliary light-entering faces 20B that is located toward the non-light-entering face 20C. A plurality of main LEDs (one example of a main light source) 28A, which will be explained later, are surface mounted on the inner surface of the long side LED substrate 30, or in other words, the plate surface facing the light guide plate 30. This surface therefore becomes the mounting surface of the LED substrate 30. Meanwhile, a plurality of auxiliary LEDs (one example of an auxiliary light source) 28B, which will explained later, are surface mounted on the inner surface of the short side LED substrates 30, or in other words, the surface facing toward the light guide plate 30. This surface therefore becomes the mounting surface of the LED substrate 30.

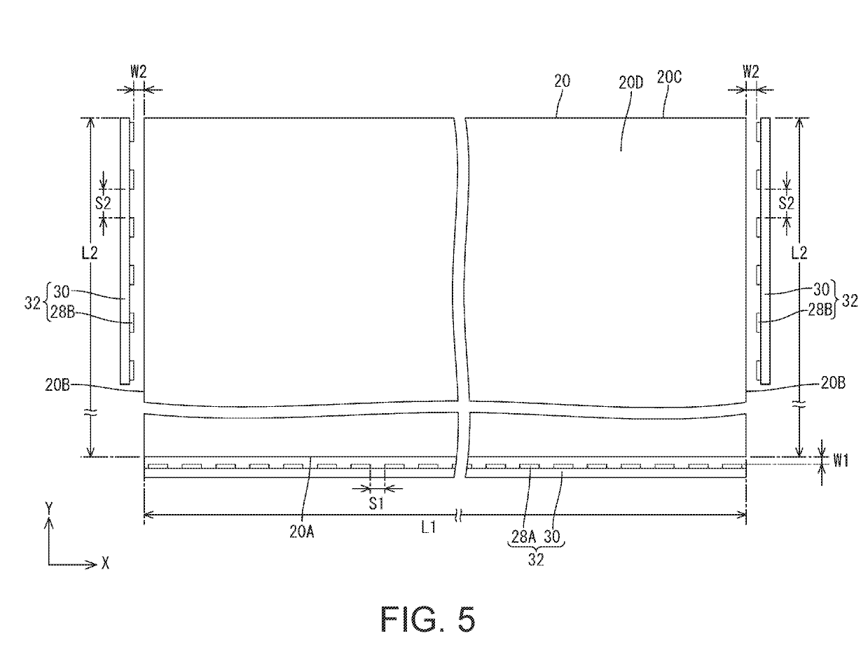

Wiring patterns (not shown) are formed on the mounting surfaces of the long side LED substrate 30 and the short side LED substrates 30. The wiring patterns are formed of a metal film (such as copper foil), extend along the long side direction of the mounting surface, and connect adjacent main LEDs 28A and adjacent auxiliary LEDs 28B in series. Terminals, which are formed at both ends of the wiring pattern, are connected to a power supply board via a wiring member such as a connector, wiring lines, or the like; thus, driving power can be supplied to the respective main LEDs 28A and the respective auxiliary LEDs 28B. The plate surfaces opposite to the mounting surfaces of the long side LED substrate 30 and the short side LED substrates 30 are respectively attached to the opposing side walls 22B, 22C of the chassis 22 via screws or the like. As shown in FIG. 5, in the present embodiment, various members are disposed such that a distance W2 between the auxiliary LEDs 28B and the auxiliary light-entering face 20B is greater than a distance W1 between the main LEDs 28A and the main light-entering face 20A.

The configurations of the main LEDs 28A and the auxiliary LEDs 28B, which form part of the LED units 32, are identical to each other. The main LEDs 28A and the auxiliary LEDs 28B have a configuration in which LED elements (not shown) are sealed via a resin on substrate sections fixed on the long side substrate 30 and the short side substrates 30. The LED elements mounted on the substrate section have one main wavelength, specifically emitting only blue light. Meanwhile, a phosphor that emits a prescribed color when excited by blue light emitted from the LED element is dispersed in a resin package that seals the LED element, and the LED element as a whole emits light that is substantially white. A yellow phosphor that emits yellow light, a green phosphor that emits green light, and a red phosphor that emits red light can be combined appropriately to form the phosphor, or only one of the phosphors can be used, for example. The main LEDs 28A and the auxiliary LEDs 28B are so-called top-emitting LEDs in which the light-emitting surface is the surface opposite to the mounting surface of the long side substrate 30 and the short side substrates 30. The light-emitting surfaces of the main LEDs 28A are disposed so as to face the main light-entering face 20A of the light guide plate 20, and the light-emitting surfaces of the auxiliary LEDs 28B are disposed so as to face the auxiliary light-entering face 20B of the light guide plate 20.

A plurality of main LEDs 28A are disposed in a row (a straight line) with substantially identical gaps therebetween along the length direction (X axis direction) of the mounting surface of the long side LED substrate 30. A plurality of auxiliary LEDs 28B are disposed in a row (a straight line) with substantially identical gaps therebetween along the length direction (Y axis direction) of the mounting surfaces of the short side LED substrates 30. In the present embodiment, the gaps between the plurality of main LEDs 28A and the gaps between the plurality of auxiliary LEDs 28B differ from each other. Specifically, as shown in FIGS. 4 and 5, a gap S2 between auxiliary LEDs 28B is larger than a gap 51 between main LEDs 28A. Put another way, the main LEDs 28A are disposed so as to have a narrower gap therebetween compared to the auxiliary LEDs 28B. In the present specification, “substantially identical gaps” means that the gaps are designed to be identical. However, this definition also includes gaps between the main LEDs 28A and gaps between the auxiliary LEDs 28B that are slightly different from the prescribed gaps as a result of the influence of the screws or the like in the long side substrate 30 and the short side substrates 30.

In the present embodiment, as a result of the above-mentioned configuration, light emitted from the main LEDs 28A is received by the main light-entering face 20A provided on the light guide plate 20, and light emitted from the auxiliary LEDs 28B is received by the auxiliary light-entering faces 20B provided on the light guide plate 20 so as to be adjacent to the main light-entering face 20A. Thus, even when a larger amount of light emitted from the main LEDs 28A becomes more focused in a central portion of the light guide plate 20 than both edge portions in the length direction (X axis direction) of the light guide plate 20, the brightness at both edge portions in the long side direction of the light guide plate 20 is increased by the light emitted from the auxiliary LEDs 28B, and uneven brightness can be prevented or suppressed between the central portion and the edge portions of the light-exiting surface 20D of the light guide plate 20. A dispersion pattern (not shown) formed of a pattern of a plurality of dots is formed on the light-exiting surface 20D of the light guide plate 20. The radius of the diffusion pattern increases moving away from the main light-entering face 20A and the auxiliary light-entering face 20B. The diffusion pattern controls the planar light distribution of light emitted from the light-exiting surface 20D such that the light distribution is uniform.

In the present embodiment, an area A1 of the main light-entering face 20A can be represented by the formula L1×T, and an area A2 of the auxiliary light-entering face 20B can be represented by the formula L2×T, where A1 is the area of the main light-entering face 20A of the light guide plate 20, A2 is the area of the auxiliary light-entering face 20B of the light guide plate 20, T (see FIG. 3) is a thickness of the light guide plate 20, L1 (see FIG. 5) is a length in the long side direction of the main light-entering face 20A, and L2 (see FIG. 5) is a length in the long side direction of the auxiliary light-entering face 20B. Since the main LEDs 28A have the same configuration as the auxiliary LEDs 28B, B1=B2, where B1 is the area of the light-emitting surfaces of the main LEDs 28A, and B2 is the area of the light-emitting surfaces of the auxiliary LEDs 28B. From FIG. 4, it can be derived that N1=26 and N2=6, where N1 is the number of main LEDs 28A, and N2 is the number of auxiliary LEDs 28B in one LED unit 32 disposed in the short side direction of the chassis 22. Thus, in the present embodiment, the respective LED units 32 having the above-mentioned disposition and configuration leads to the following relational expression (1) among the one LED unit 32 disposed on the one long side of the chassis 22, the two LED units 32 respectively disposed on the respective two short sides of the chassis 22, and the light guide plate 20.

B1×N1÷A1>B2×N2÷A2 (1)

The relational expression (1) shows that the ratio of the area of the light-emitting surfaces of the auxiliary LEDs 28B to the auxiliary light-entering face 20B of the light guide plate 20 is less than the ratio of the area of the light-emitting surfaces of the main LEDs 28A to the main light-entering face 20A of the light guide plate 20. As a result of this relationship, the auxiliary LEDs 28B are able to function as supplementary light sources to the main LEDs 28A. In other words, light from the main LEDs 28A makes up a large portion of the light emitted from the light-exiting surface 20D of the light guide plate 20, while light from the auxiliary LEDs 28B functions as supplementary light for preventing or suppressing uneven brightness in the light-exiting surface 20D by increasing the brightness at both edge portions in the long side direction of the light guide plate 20. When the letters and values described in the preceding paragraph are inserted into the relational expression (1), the following relational expression (2) is derived for the backlight device 24 of the present embodiment.

26×L2>6×L1 (2)

In this way, in a backlight device 24 according to the present embodiment, the auxiliary light-entering faces 20B are provided on the end faces of the light guide plate 20 so as to be adjacent to the main light-entering face 20A. Moreover, not only does the main light-entering face 20A receive light emitting from the main LEDs 28A, but the auxiliary light-entering faces 20B adjacent to the main light-entering face 20A receive light from the auxiliary LEDs 28B. Thus, even if a larger amount of light becomes focused in the center of the main light-entering face 20A compared to the edges thereof, it is possible to prevent or suppress insufficient brightness at the edges of the main light-entering face 20A. Since the light guide plate 20 has a rectangular shape, when thermal expansion occurs, the light guide plate 20 expands further outward in the short side direction than in the long side direction. Therefore, when the light guide plate 20 thermally expands, the distance to which the auxiliary light-entering face 20B expands toward the auxiliary LEDs 28B is greater than the distance to which the main light-entering face 20A expands toward the main LEDs 28A. As a result, in order to prevent the auxiliary LEDs 28B from impacting and damaging the auxiliary light-entering face 20B when the light guide plate 20 thermally expands, the auxiliary LEDs 28B are disposed such that W2, which is the distance between the auxiliary LEDs 28B and the auxiliary light-entering face 20B, is larger than W1, which is the distance between the main LEDs 28A and the main light-entering face 20A. As a result, the amount of light received by the auxiliary light-entering face 20B is less than the amount of light received by the main light-entering face 20A. Thus, in the backlight device 24 of the present embodiment, the auxiliary LEDs 28B function as supplementary light sources.

However, in instances in which the number of auxiliary LEDs 28B is increased too much or the like, depending on the arrangement of the main LEDs 28A, the amount of light that the auxiliary light-entering faces 20B receive may be greater than the amount of light that the main light-entering face 20A receives, which means that the auxiliary LEDs 28B no longer function as supplementary light sources, and that the brightness at the main light-entering face 20A side of the display surface 11C of the liquid crystal panel 11 may decrease relative to the auxiliary light-entering face 20B sides. As a countermeasure, the backlight device 24 of the present embodiment is configured such that the main LEDs 28A and the auxiliary LEDs 28B are respectively disposed such that the ratio of the light-emitting surfaces of the auxiliary LEDs 28B to the auxiliary light-entering faces 20B provided on the short-side end faces of the light guide plate 20 is less than the ratio of the light-emitting surfaces of the main LEDs 28A to the main light-entering face 20A provided on a long-side end face of the light guide plate 20. Thus, the respective main LEDs 28A and the respective auxiliary LEDs 28B are efficiently arranged, and it is possible to efficiently cause light to enter the main light-entering face 20A and the auxiliary light-entering faces 20B without negatively impacting the ability of the auxiliary LEDs 28B to function as supplementary light sources. As a result, it is possible to prevent or suppress a state in which the center of the light-entering face 20A is brighter than the edges thereof, and it is also possible to prevent or suppress uneven brightness between the center and the edges of the light-exiting surface 20D. It is also possible to prevent a decrease in the usage efficiency of light because the backlight device 24 does not include a lens member or the like in the middle of the path of the light as in conventional technology. In this way, in the backlight device 24 of the present embodiment, it is possible to improve uniformity in brightness distribution on the light-exiting surface 20D without decreasing the usage efficiency of the light.

Also in the present embodiment, both short-side end faces of the light guide plate 20 are auxiliary light-entering faces 20B. As a result of such a configuration, light is received at both respective end faces adjacent to both sides of the main light-entering face 20A; thus, compared to instances in which light is received at only one end face adjacent to the main light-entering face 20A, it is possible to further prevent or suppress insufficient brightness at the edges of the main light-entering face 20A. Thus, it is possible to further prevent or suppress uneven brightness between the center and the edges of the light-exiting surface 20D.

In addition, in the present embodiment, one long-side end face of the light guide plate 20 is the main light-entering face 20A. Furthermore, the auxiliary LEDs 28B are disposed closer to another long-side end face of the light guide plate 20. As in the present embodiment, when the one long-side end face of the light guide plate 20 is the main light-entering face 20A, it is difficult for light from the main LEDs 28A to reach the end face opposite to the main light-entering face 20A, or in the other words, the other long-side end face of the light guide plate 20. As a countermeasure, by using the above-mentioned configuration in the present embodiment, it is possible to prevent or suppress insufficient brightness at the end face side of the light-exiting surface 20D that is opposite to the main light-entering face 20A since the light from the auxiliary LEDs 28B is closer to the end face opposite to the main light-entering face 20A. As a result, it is possible to further increase brightness uniformity on the light-exiting surface 20D.

Also in the present embodiment, the main LEDs 28A are disposed so as to face substantially the entire main light-entering face 20A. By using such a configuration, it is easier for light to enter both ends of the main light-entering face 20A; thus, it is possible to prevent or suppress insufficient brightness in the corners of the light-exiting surface 20D at both ends on the main light-entering face 20A side. As a result, it is possible to further increase brightness uniformity on the light-exiting surface 20D.

In the present embodiment, light emitted from the LEDs not only enters the main light-entering face 20A, but also enters the auxiliary light-entering faces 20B. Thus, heat generated by the main LEDs 28A and the auxiliary LEDs 28B is dispersed, and the temperature distribution of the light-exiting surface 20D is spread out evenly. As a result, it is possible to prevent or suppress heat generated from the main LEDs 28A and the auxiliary LEDs 28B from becoming concentrated in a portion of the light-exiting surface 20D. In this manner, it is possible to lengthen product life and prevent or suppress wrinkling of the optical sheet 18.

### Modification Example of Embodiment 1

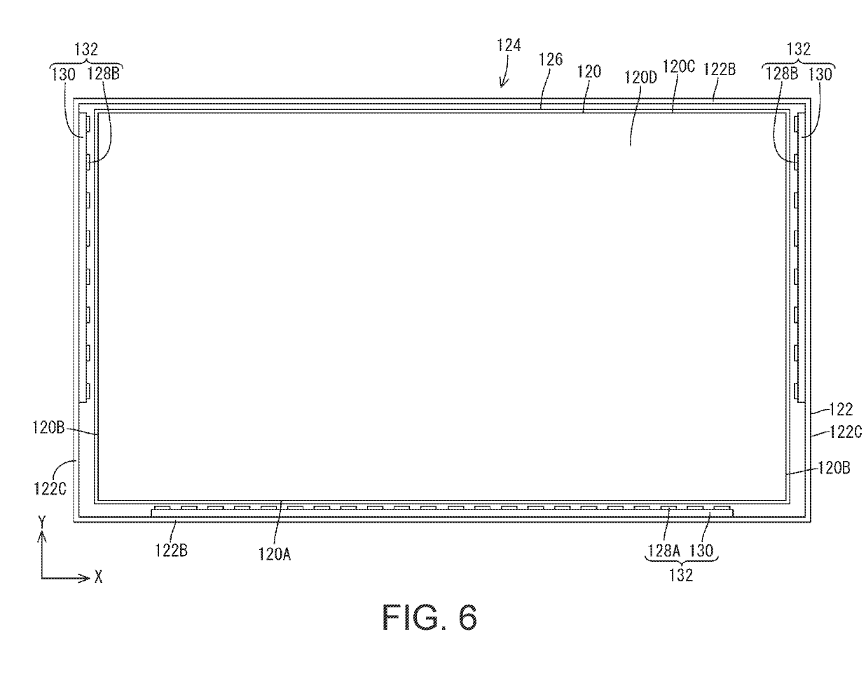

Next, a modification example of Embodiment 1 will be described. In the present modification example, the number of the main LEDs 128A and the auxiliary LEDs 128B differs from Embodiment 1. Other configurations are the same as those of Embodiment 1, and therefore, descriptions of the structures, the operation, and the effects will be omitted. Parts in FIG. 6 that have 100 added to the reference characters of FIG. 4 are the same parts as described in Embodiment 1. As shown in FIG. 6, in a backlight device 124 of the present modification example, the number of main LEDs 128A on a long side LED substrate 130 is less than in Embodiment 1. Specifically, in this modification example, two main LEDs 128A have been removed from both ends of the main LEDs 128A disposed on the long side LED substrate 130 from Embodiment 1. Also, compared to Embodiment 1, the length in the long side direction of the long side LED substrate 130 has been decreased since the number of main LEDs 128A has been reduced.

Meanwhile, in the present modification example, the number of auxiliary LEDs 128B disposed on each of the respective short side LED substrates 130 has been increased by two compared to Embodiment 1. Also, compared to Embodiment 1, the length in the long side direction of the short side LED substrates 130 has been increased since the number of auxiliary LEDs 128B has increased. In this manner, even if the number of main LEDs 128A and auxiliary LEDs 128B has been modified from Embodiment 1, a relationship is maintained in the present modification example in which the ratio of the area of the light-emitting surfaces of the auxiliary LEDs 128B to the auxiliary light-entering face 120B of the light guide plate 120 is smaller than the ratio of the area of the light-emitting surfaces of the main LEDs 128A to the main light-entering face 120A of the light guide plate 120. Thus, it is possible to increase uniformity in brightness distribution on the light-exiting surface 120D without decreasing the usage efficiency of light while still having the auxiliary LEDs 128 function as auxiliary light sources to the main LEDs 128A.

### Embodiment 2

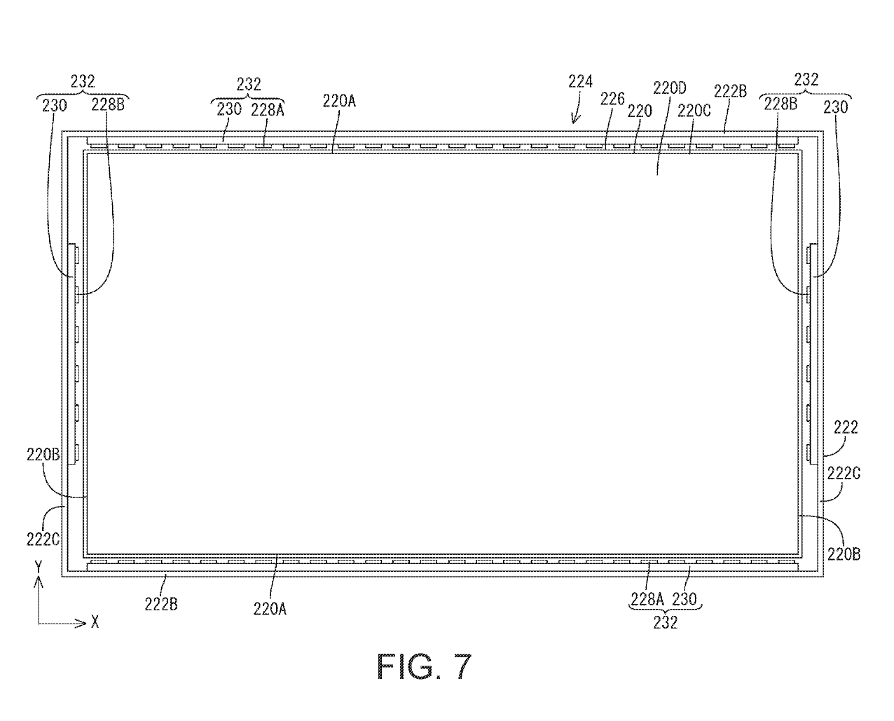

Embodiment 2 will be described with reference to the drawings. Embodiment 2 differs from Embodiment 1 in the arrangement of the LED units. Other configurations are similar to those of Embodiment 1; thus, descriptions of the configurations, operation, and effects will be omitted. Parts in FIG. 7 that have 200 added to the reference characters of FIG. 4 are the same parts as described in Embodiment 1.

As shown in FIG. 7, a backlight device 224 according to Embodiment 2 includes four LED units 232. In other words, LED units 232 are respectively disposed on both long sides of a chassis 222, and LED units 232 are respectively disposed on both short sides of the chassis 222. The respective LED units 232 disposed on both long sides of the chassis 222 include main LEDs 228A and long side LED substrates 230 that have a configuration identical to that in Embodiment 1, and the respective LED units 232 disposed on both short sides of the chassis 222 include auxiliary LEDs 228B and short side LED substrates 230 that have a configuration identical to that in Embodiment 1. In addition, the respective short side LED substrates 230 differ from those in Embodiment 1, and are respectively disposed so as to be in a substantially central location with respect to a main light-entering face 320A side and a non-light-entering face 320C side.

In the present embodiment, by having both respective long-side end faces of a light guide plate 220 be main light-entering faces 220A in the manner described above, a large portion of the light from the main LEDs 228A and the auxiliary LEDs 228B enters the light guide plate 220 from both respective long-side end faces of the light guide plate 220. Thus, compared to cases in which one long-side end face of the light guide plate 220 is a main light-entering face 220A, it is possible to increase brightness throughout the light-exiting surface 220D.

### Modification Example of Embodiment 2

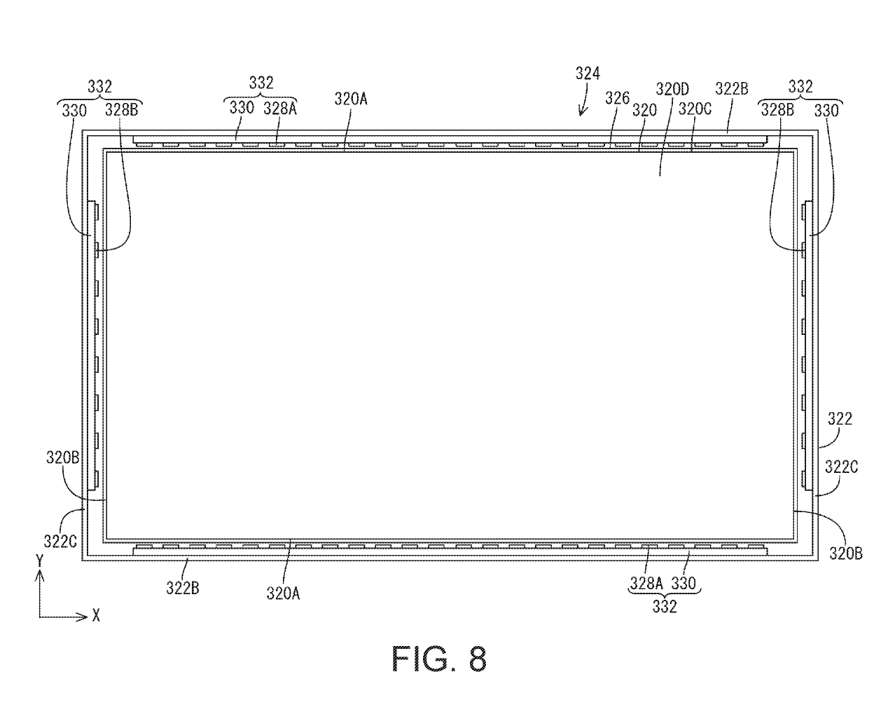

Next, a modification example of Embodiment 2 will be described. In the present modification example, the number of the main LEDs 328A and auxiliary LEDs 328B differs from Embodiment 2. Other configurations are the same as those of Embodiment 2, and therefore, descriptions of the structures, the operation, and the effects will be omitted. Parts in FIG. 8 that have 300 added to the reference characters of FIG. 4 are the same parts as described in Embodiment 1. As shown in FIG. 8, a backlight device 324 according to the present modification example has a configuration that differs from Embodiment 2 in that there are fewer main LEDs 328A on respective long side LED substrates 330. Specifically, in this modification example, one main LED 328A has been removed from each end of the main LEDs 328A disposed on the respective long side LED substrates 330 from Embodiment 2. Also, compared to Embodiment 2, the length in the long side direction of the long side LED substrates 330 has been decreased since the number of main LEDs 328A has been reduced.

Meanwhile, in the present modification example, the number of auxiliary LEDs 328B disposed on each of the respective short side LED substrates 330 has been increased by one compared to Embodiment 2. Also, compared to Embodiment 1, the length in the long side direction of the short side LED substrates 330 has been increased since the number of auxiliary LEDs 328B has increased. In this manner, even if the number of main LEDs 328A and auxiliary LEDs 328B has been modified from Embodiment 1, a relationship is maintained in the present modification example in which the ratio of the area of the light-emitting surfaces of the auxiliary LEDs 328B to the auxiliary light-entering face 320B of the light guide plate 320 is smaller than the ratio of the area of the light-emitting surfaces of the main LEDs 328A to the main light-entering face 320A of the light guide plate 320. Thus, it is possible to increase uniformity in brightness distribution on the light-exiting surface 320D without decreasing the usage efficiency of light while still having the auxiliary LEDs 328 function as auxiliary light sources to the main LEDs 328A.

### Embodiment 3

Next, Embodiment 3 will be described. Embodiment 3 differs from Embodiments 1 and 2 in that the television receiver does not include a cabinet or a bezel. Other than a heat dissipating member 436, which will be explained hereafter, other configurations of Embodiment 3 are the same as those of Embodiment 1, and therefore, descriptions of the structures, the operation, and the effects will be omitted.

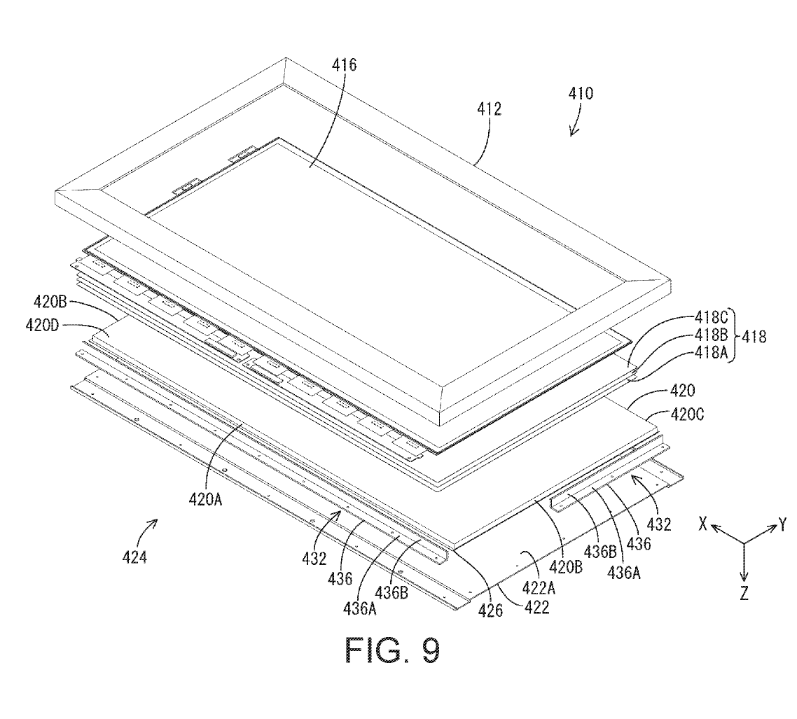

As shown in FIG. 9, the main constituting components of a liquid crystal display device 410 according to Embodiment 3 are housed in a housing space formed between a frame 412 that forms a front exterior and a chassis 422 that forms the rear exterior. The main constituting components housed inside the frame 412 and the chassis 422 include, at a minimum: a liquid crystal panel 416; an optical member 418; a light guide plate 420; LED units 432; and the heat dissipating member 436. Of these, the liquid crystal panel 416, the optical member 418, and the light guide plate 420 are stacked on one another and held by being sandwiched by the frame 412 on the front side thereof and the chassis 422 on the back side thereof.

The respective LED units 432 are formed of: a long side LED substrate (short side LED substrate) 430; main LEDs (auxiliary LEDs); and the heat dissipating member 436. The heat dissipating member 436 is formed of a metal with excellent thermal conductivity, such as aluminum, for example, and includes: a rising portion 436B to which the long side LED substrate (short side LED substrate) 430 is attached; and a bottom face 436A that makes surface-to-surface contact with a bottom plate 422A of the chassis 422. These two parts that form the heat dissipating member 436 have a bent shape that is approximately in the shape of an “L” when seen in a cross-section. The bottom face 436A has a plate-like shape that is parallel to the bottom plate 422A of the chassis 422, and extends from a rear end (chassis 422 side end) of the rising section 436B toward the exterior along the Y axis direction. The rising section 436B rises perpendicular to the bottom plate 436A, and has a plate-like shape that is parallel to the main light-entering face 420A (auxiliary light-entering face 420B) of the light guide plate 420.

In the present embodiment, similar to Embodiment 1, one LED unit 432 formed of a long side LED substrate and main LEDs is disposed on one long side of the chassis 422, and LED units 432 formed of a short side LED substrate and auxiliary LEDs are respectively formed on both short sides of the chassis 422. The configuration, disposition, and the like of the long side LED substrate, the short side LED substrate, the main LEDs, and the auxiliary LEDs is the same as in Embodiment 1. By using such a configuration, even in instances such as in the present embodiment in which the backlight device does not include a cabinet or a bezel, it is possible to increase uniformity in brightness distribution on the light-exiting surface 420D without decreasing the usage efficiency of light while still having the auxiliary LEDs function as supplementary light sources.

Modification examples of the respective embodiments mentioned above will be described below.

(1) In the respective above-described embodiments, an example was used in which LED units (auxiliary LEDs) were respectively disposed on both short sides of the light guide plate. However, an LED unit (auxiliary LEDs) may be disposed on only one short side of the light guide plate. Even in such a case, it is possible to increase brightness between the center and edges of the light-exiting surface of the light guide plate since there is an increase in brightness at one end section in the long side direction of the light guide plate.

(2) In the respective above-described embodiments, an example was used in which gaps between adjacent main LEDs and gaps between adjacent auxiliary LEDs were respectively substantially identical. However, the gaps between adjacent main LEDs and the gaps between auxiliary LEDs need not be respectively identical.

(3) In the respective above-described embodiments, an example was used in which the main LEDs and the auxiliary LEDs had an identical configuration. The main LEDs and the auxiliary LEDs may have differing configurations, however. As long as the auxiliary LEDs function as supplementary light sources to the main LEDs, the main LEDs may be 2-in-1 LEDs and the auxiliary LEDs may be 1-in-1 LEDs, for example. In addition, in accordance with the change in the radius of the respective patterns in the diffusion pattern formed on the light-exiting surface, or in other words, in accordance with the degree to which the light distribution is controlled, the device may be configured such that the amount and the like of light emitted from the respective LEDs in the auxiliary LEDs may differ such that the light distribution on the light-exiting surface becomes even.

(4) In addition to the respective above-described embodiments, it is possible to appropriately modify the arrangement, number, and the like of the main LEDs and the auxiliary LEDs.

(5) In the respective above-described embodiments, an example was used of a liquid crystal display device that utilized a liquid crystal panel as a display panel. The present invention is also applicable to a display device that utilizes another type of display panel, however.

(6) In the respective above-described embodiments, an example was used of a television receiver that includes a tuner. The present invention is also applicable to a display device without a tuner, however.

Embodiments of the present invention were described above in detail, but these are only examples, and do not limit the scope as defined by the claims. The technical scope defined by the claims includes various modifications of the specific examples described above.

### DESCRIPTION OF REFERENCE CHARACTERS

TV television receiver
Ca, Cb cabinet
T tuner
S stand
10, 410 liquid crystal display device
12 bezel
14 frame
16 liquid crystal panel
18 optical member
20, 120, 220, 320, 420 light guide plate
20A, 120A, 220A, 320A, 420A main light-entering face
20B, 120B, 220B, 320B, 420B auxiliary light-exiting surface
22, 122, 222, 322, 422 chassis
24, 124, 224, 324, 424 backlight device
28A, 128A, 228A, 328A main LED
28B, 128B, 228B, 328B auxiliary LED
30, 130 LED substrate
32, 132, 232, 332, 432 LED unit

1: An illumination device, comprising:
a light guide plate that has a rectangular plate-like shape, at least one long-side end face thereof being a main light-entering face and at least one short-side end face thereof being an auxiliary light-entering face;
a plurality of main light sources disposed in a line along the main light-entering face, such that light emitted by said main light sources enters said main light-entering face; and
a plurality of auxiliary light sources disposed in a line along the auxiliary light-entering face, such that light emitted by said auxiliary light sources enters said auxiliary light-entering face,
wherein a ratio of a total area of light-emitting surfaces of the auxiliary light sources to an area of the auxiliary light-entering face is less than a ratio of a total area of light-emitting surfaces of the main light sources to an area of the main light-entering face.

2: The illumination device according to claim 1,
wherein the main light sources are disposed such that the light-emitting surfaces thereof face the main light-entering face,
wherein the auxiliary light sources are disposed such that the light-emitting surfaces thereof face the auxiliary light-entering face, and
wherein the ratio of the total area of the light-emitting surfaces of the main light sources to the area of the main light-entering face is represented by the formula B1×N1÷A1, and the ratio of the total area of the light-emitting surfaces of the auxiliary light sources to the area of the auxiliary light-entering face is represented by the formula B2×N2÷A2, where A1 and A2 represent the area of the main light-entering face and the area of the auxiliary light-entering face, respectively, B1 and B2 represent an area of the light-emitting surface of each of the main light sources and an area of the light-emitting surface of each of the auxiliary light sources, respectively, and N1 and N2 represent a number of the main light sources and a number of the auxiliary light sources, respectively.

3: The illumination device according to claim 1,
wherein the main light sources that are disposed adjacent to each other have a substantially equal gap therebetween,
wherein the auxiliary light sources that are disposed adjacent to each other have a substantially equal gap therebetween, and
wherein the main light sources are disposed with a narrower gap therebetween than the auxiliary light sources.

4: The illumination device according to claim 1, wherein both short-side end faces of the light guide plate are respectively the auxiliary light-entering face.

5: The illumination device according to claim 1,
wherein only one of the long-side end faces of the light guide plate is the main light-entering face, and
wherein a distribution of the auxiliary light sources is closer to another of the long-side end faces of the light guide plate relative to said only one of the long-side end faces.

6: The illumination device according to claim 1, wherein both long-side end faces of the light guide plate are respectively the main light-entering face.

7: The illumination device according to claim 1, wherein the main light sources are disposed so as to face almost the entire main light-entering face.

8: A display device, comprising:
the illumination device according to claim 1; and
a display panel that utilizes light from the illumination device to perform display.

9: The display device according to claim 8, wherein the display panel is a liquid crystal panel that utilizes liquid crystal.

10: A television receiver, comprising:
the display device according to claim 8.
